(19) United States
(12) Patent Application Publication
(10) Pub. No.: US 2009/0211963 A1
(43) Pub. Date: Aug. 27, 2009

(54) Particle Interceptor

(75) Inventors: Christopher Adam Murray, Oakville (CA); Balreet Singh Dandiwal, Brampton (CA); John Regan Walker, Oakville (CA)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Green Turtle Technologies America Limited

(21) Appl. No.: 12/038,541

(22) Filed: Feb. 27, 2008

(51) Int. Cl. B01D 21/24; B01D 39/14; B01D 39/16

(52) U.S. Cl. 210/433.1; 210/500.21; 210/500.27

(57) ABSTRACT

An interceptor having a filter chamber, an inlet passage connected to the filter chamber at an inlet opening, and an outlet passage connected to the filter chamber at an outlet opening. The outlet opening is above the inlet opening and has a minimum outlet flow elevation at which fluid can pass therethrough. A filter may be in the filter chamber between the inlet and outlet openings such that fluid passing from the inlet opening to the outlet opening must pass through the filter. A bypass passage fluidly connects the inlet passage to the outlet passage. The bypass may have a minimum bypass flow elevation at which fluid can pass through the bypass passage, the minimum bypass flow elevation being higher than the minimum outlet flow elevation. The bypass may be adapted to allow flow therethrough only when a flow resistance between the inlet and the filter exceeds a threshold value.

### FIELD OF THE INVENTION

The present invention relates to devices and methods for removing particles from a stream of fluid coming from commercial sinks or other fluid streams.

### BACKGROUND OF THE INVENTION

Commercial and household culinary activities often generate unwanted byproducts that may be discarded by simply washing them down a sink with a stream of water. Such byproducts often include liquids (e.g., oil or grease) and/or particulate matter, such as pieces of food, dirt or grit, bone chips, gelatin, fat, meat, coffee grounds, eggshells, and so on. The variety of such particles is virtually limitless. In many cases, the water and entrained particles pass freely through the sink and its associated plumbing to a sewer line, treatment facility, or pre-treatment storage tank. In some cases, however, the particles may accumulate in the sink's plumbing, leading to constriction or blockage. When excessive constriction or blocks develop, the plumbing must be cleared by locating and removing the accumulated particles (or object), sometimes at great cost. Repeated blockages can also be a nuisance and a detriment to productivity.

A number of attempts have been made to reduce the likelihood and/or frequency of plumbing constriction and blockages. For example, many household sinks use a garbage disposal to grind or macerate particles into smaller pieces that pass more freely through the plumbing. While disposals may be effective for relatively small volumes of particles, they can be expensive to purchase and operate, and are subject to mechanical failure and may become less effective over time. Thus, disposals often are not desired by commercial establishments.

Other devices for removing particles from fluid streams use gravity, buoyancy, filters, or screens to remove the particles. For example, the device illustrated in European Patent 0 529 464 B1 appears to disclose an under-sink separator tank having a settling chamber in which gravity and buoyancy separate heavier and lighter substances from the fluid, as well as vertical walls that skim the fluid and prevent removed materials from passing through the settling chamber. Other devices, such as the device sold commercially as the Model GDQ-B13 Strainer Drawer by the Drain-Net company of Branchburg, N.J., provide a simple screen located in a chamber below the sink. In this device, the water flows downward into the chamber and passes downward through the screen to remove particles from the water. The screen is mounted in a drawer-like frame that can be removed from the chamber to clean the screen when it becomes blocked. Still other devices, such as the PHIX™ cartridge system provided by Green Turtle (USA) of Charlotte, N.C. and Green Turtle Technologies of Mississauga ON provide a useful filtration device for conditioning sink water, but can become blocked if large objects or large volumes of smaller objects enter the system. In addition, if it is desired to disassemble the PHIX™ cartridge system without spillage, fluid must be siphoned out of the device through the inlet, which can be problematic if the inlet is clogged.

Despite the shortcomings of the prior art, the prior art systems may be quite useful under some circumstances, and their shortcomings may be inconsequential in particular applications. As such, the description of the foregoing prior art is not intended to limit the present invention to solving all of the problems identified in the prior art, and various features of the prior art may be incorporated into embodiments of the present invention. The present invention adds to the prior art by providing unique and novel features and systems to provide alternatives and useful and nonobvious modifications to the known particle removing apparatus.

### SUMMARY OF THE INVENTION

In one exemplary aspect, an interceptor is provided. The interceptor includes a filter chamber, an inlet passage fluidly connected to the filter chamber at an inlet opening, and an outlet passage fluidly connected to the filter chamber at an outlet opening. The outlet opening is located above the inlet opening and has a minimum outlet flow elevation at which fluid can pass through the outlet passage. A filter is positioned in the filter chamber between the inlet opening and the outlet opening such that substantially all of the fluid passing from the inlet opening to the outlet opening must pass through the filter. A bypass passage fluidly connects the inlet passage to the outlet passage. The bypass passage has a minimum bypass flow elevation at which fluid can pass through the bypass passage. The minimum bypass flow elevation is higher than the minimum outlet flow elevation.

In another exemplary aspect, another interceptor is provided. The interceptor includes a filter chamber, an inlet passage fluidly connected to the filter chamber at an inlet opening, and an outlet passage fluidly connected to the filter chamber at an outlet opening. The outlet opening is located above the inlet opening. A filter is positioned in the filter chamber between the inlet opening and the outlet opening such that substantially all of the fluid passing from the inlet opening to the outlet opening must pass through the filter. A bypass passage fluidly connects to the inlet passage at a first point, and to the outlet passage at a second point. The bypass passage is adapted to allow flow therethrough only when a flow resistance between the first point and the filter exceeds a threshold value.

In another exemplary aspect, another interceptor is provided. The interceptor includes a treatment chamber comprising a lid and a container. The container has an open top adapted to removably connect to the bottom of the lid. The interceptor also has an inlet passage fluidly connected to the treatment chamber at an inlet opening, and an outlet passage extending through the lid and fluidly connected to the treatment chamber at an outlet opening. The outlet opening is located above the inlet opening and has a minimum outlet flow elevation at which fluid can pass through the outlet passage. A displacement member is associated with the lid, the displacement member extends into the container when the container is attached to the lid. The treatment chamber and the outlet passage define a first volume when the container is connected to the bottom of the lid. The first volume includes a first internal space within at least one of the treatment chamber and outlet passage located vertically between the minimum outlet flow elevation and a lowermost point of the open top of the container. The displacement member occupies a second volume within the container when the container is connected to the bottom of the lid. The second volume being equal to or greater than the first volume.

In another exemplary embodiment, another interceptor is provided. The interceptor may be adapted for treating a generally homogeneous mixture of fluid and particles, and may have a treatment chamber, an inlet passage that is fluidly connected to the treatment chamber at an inlet opening and adapted to receive a generally homogeneous mixture of fluid and particles, and an outlet passage fluidly connected to the treatment chamber at an outlet opening. The outlet opening is located above the inlet opening and has a minimum outlet flow elevation at which fluid can pass through the outlet passage. A bypass passage fluidly connects the inlet passage to the outlet passage. The bypass passage has a minimum bypass flow elevation at which fluid can pass through the bypass passage. The minimum bypass flow elevation is higher than the minimum outlet flow elevation. The treatment chamber has one or more vertical passages between the inlet opening and the outlet opening, which passages are sized, in relation to a maximum flow rate of the generally homogeneous mixture, to cause a majority of the particles to precipitate out of the fluid before the fluid reaches the outlet opening.

### BRIEF DESCRIPTION OF THE DRAWINGS

Illustrations of various exemplary embodiments are provided in the following drawings, in which like reference characters are used to indicate like elements.

FIG. 1 is a partially cut away, exploded isometric view of a first exemplary embodiment of a particle interceptor.

FIG. 2 is a partially cut away isometric view of the particle interceptor of FIG. 1, showing a first flow condition through the particle interceptor.

FIG. 3 is a partially cut away isometric view of the particle interceptor of FIG. 1, showing a second flow condition through the particle interceptor.

FIG. 4 is schematic elevation view illustrating the particle interceptor of FIG. 1 installed in a sink's plumbing system.

FIG. 5 is schematic elevation view illustrating an alternative exemplary embodiment of a particle interceptor installed in a sink's plumbing system.

FIG. 6 is schematic elevation view illustrating another alternative exemplary embodiment of a particle interceptor installed in a sink's plumbing system.

### DETAILED DESCRIPTION OF EXEMPLARY EMBODIMENTS

The following description is intended to convey an understanding of the inventions disclosed herein by describing a number of exemplary embodiments of devices that are adapted to operate as interceptors or traps for removing solid or highly viscous materials (e.g., oil, grease, coffee grounds, fats, cleaning solvents, buoyant solids, etc.) from sink water or other fluid flows. It will be appreciated that the present invention is not limited to the exemplary embodiments, the figures, the summary of the invention, the abstract, or to any other specific disclosures herein. For example, embodiments of the invention may be used in settings other than the commercial sink environment described herein, may be sized or shaped to be used in any suitable manner, may be adapted to remove materials other those described herein, and so on. It is further understood that one possessing ordinary skill in the art will appreciate the use of the invention for purposes and benefits in any number of alternative embodiments, depending upon specific design needs and other considerations, and may adapt or use the embodiments to obtain benefits, or for purposes other than, those described herein.

The terminology used herein is for the purpose of describing particular embodiments only, and is not intended to limit the scope of the present invention. As used throughout this disclosure, the singular forms “a,” “an,” and “the” include the plural unless the context clearly dictates otherwise. Thus, for example, a reference to “an inlet” includes a plurality of inlets, or other equivalents or variations thereof known to those skilled in the art. Furthermore, the description of some embodiments or features using permissive language (e.g., “may”) is not intended to suggest that embodiments or features described using other language (e.g., “is,” “are,” etc.) are required of all embodiments or otherwise are not optional. Unless defined otherwise, all technical and scientific terms used herein have the same meanings as commonly understood by one of ordinary skill in the art to which this invention belongs.

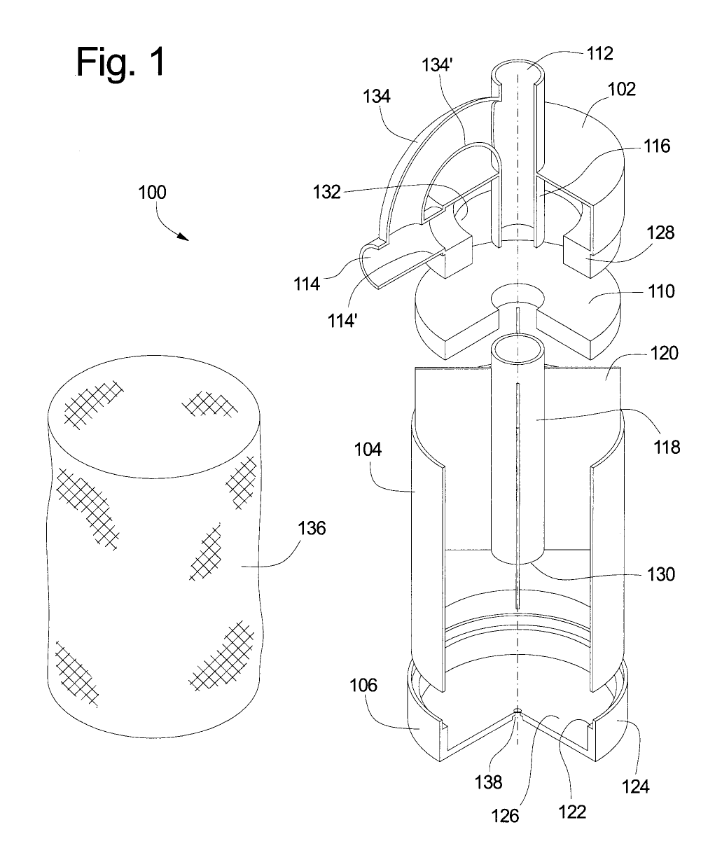

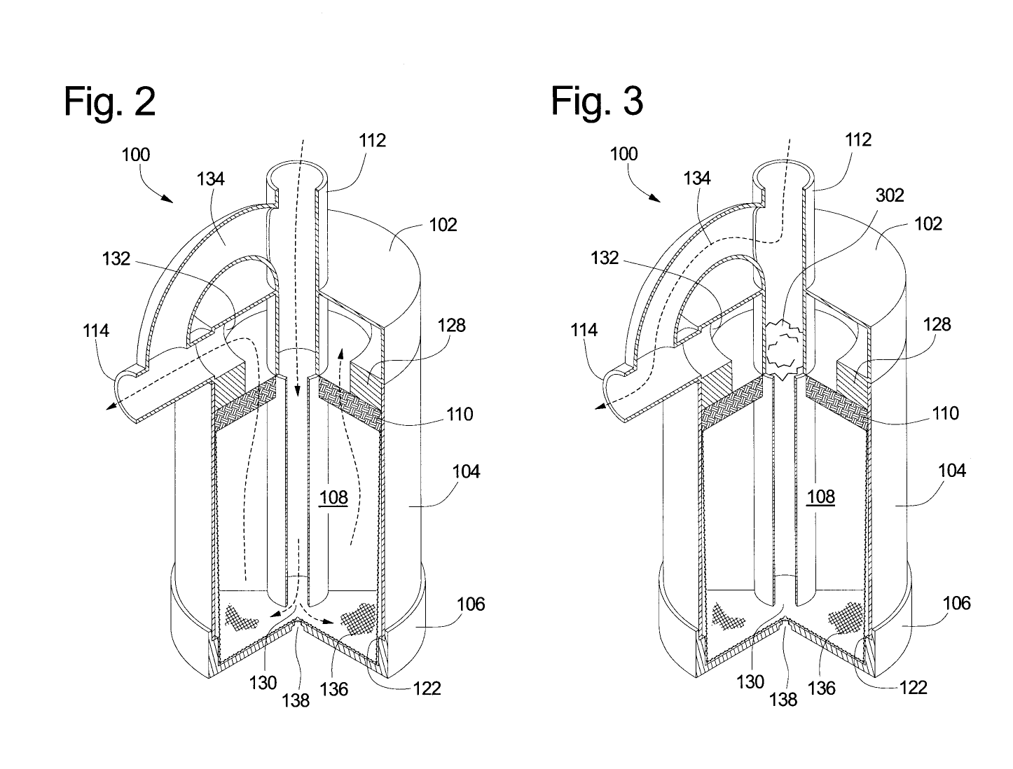

A first exemplary embodiment of an interceptor 100 is shown partially cut away and exploded in FIG. 1, and assembled in FIGS. 2 and 3. Generally, the interceptor 100 includes a treatment chamber and fluid passages entering and exiting the treatment chamber. The exemplary interceptor 100 includes a lid 102 that is removably attached to a filter chamber wall 104, and a filter chamber bottom 106 that is attached to the bottom of the filter chamber wall 104. Together, the lid 102, filter chamber wall 104, and filter chamber bottom 106 form an enclosed filter chamber 108 in which a filter 110 may be positioned. The filter chamber wall 104 (or the other parts) may be transparent or include a window to view inside the filter chamber 108. For example, the filter chamber wall 104 may comprise a transparent plastic material. One or more seals, such as o-rings or gaskets (not shown) may be used to help provide a water resistant seal between the lid 102, filter chamber wall 104, and filter chamber bottom 106.

One or more fasteners may be provided between the lid 102, filter chamber wall 104 and filter chamber bottom 106 to hold them together during use. For example, toggle clamps (not shown) may be provided on the filter chamber wall 104 to selectively engage corresponding latches (not shown) on the lid 102, and the bottom of the filter chamber wall 104 may be adhesively bonded or otherwise permanently attached to the filter chamber bottom 106. In this arrangement, the filter chamber wall 104 and filter chamber bottom 106 may provide a removable container that can be detached from the lid 102 for emptying and maintenance. Of course, other suitable attachment arrangements may be used. For example, threaded fasteners may be provided to engage the lid 102 and filter chamber bottom 106 and compress the filter chamber wall 104 in place between them, or corresponding threads may be formed on the filter chamber wall 104 and lid 102 and/or filter chamber bottom 106 to allow the parts to be screwed together. Other attachments, such as friction fitment, bayonet fittings, welds, and so on, may be used instead.

As shown, the filter chamber 108 may comprise a vertically-oriented cylindrical chamber (i.e., a cylindrical chamber having its axis of symmetry oriented vertically), but this it not required. For example, the lid 102, filter chamber wall 104, and filter chamber bottom 106 may be shaped or configured to provide a cubical or rectilinear filter chamber or a filter chamber having any number of other shapes. In addition, while the lid 102, filter chamber wall 104, and filter chamber bottom 106 are shown as separate parts that can be assembled and disassembled for cleaning and maintenance, they may be permanently attached or formed integrally with one another.

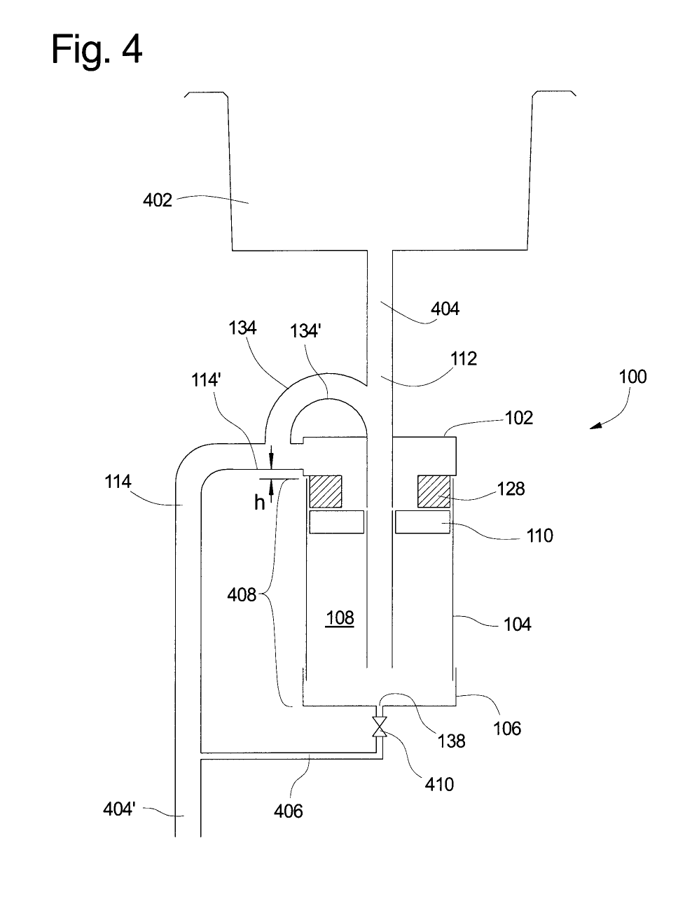

The interceptor 100 includes an inlet 112 and an outlet 114, both of which form passages into the filter chamber 108. As shown, the inlet 112 and outlet 114 may comprise passages that are integrally formed with or attached to the lid 102. One advantage of providing the inlet 112 and outlet 114 as part of the lid 102 is that the inlet 112 and outlet 114 may be attached to a sink's drain pipe 404, 404′ (FIG. 4), and the filter chamber wall 104 and filter chamber bottom 106 can be removed without disturbing this connection. Despite this advantage, the foregoing structure is not required. For example, in other embodiments, the inlet 112 and/or outlet 114 may be provided as part of the filter chamber wall 104, or located elsewhere, to provide fluid passages into the filter chamber 108.

In the embodiment of FIG. 1, the inlet 112 comprises a first inlet passage 116 that passes through the top of the lid 102 and into the radial center of the cylindrical filter chamber 108. The first inlet passage 116 may terminate at the bottom of the lid 102, as shown, or it may continue further down into the filter chamber 108. In the shown embodiment, the first inlet passage 116 abuts a second inlet passage 116 (shown partially cut away in FIGS. 2 and 3) that extends the inlet 112 towards the bottom of the filter chamber 108. A gap is provided between the end of the inlet 112 and the filter chamber bottom 106 to allow fluid to pass from the inlet 112 into the filter chamber 108. A seal, such as a labyrinthine seal, mating threads, an o-ring, a gasket, or the like, may be provided between the first and second inlet passages 116, 118 to provide a fluid-resistant seal at their junction or to join these parts together.

In the embodiment of FIG. 1, the inlet 112 comprises a pair of serially-arranged passages 116, 118, with the second inlet passage 118 being used to extend the reach of the inlet 112 further down into the filter chamber 108. It will be understood that this is not required in all embodiments, and other arrangements may be used. For example, the inlet 112 may comprise a plurality of parallel passages, such as multiple passages, similar to the first inlet passage 116, that enter the filter chamber 108 at different locations. As another example, the inlet 112 may comprise a plurality of parallel passages that receive fluid from multiple sinks or other sources, and collect it into a single passage similar to the first inlet passage 116. The inlet 112 also may provide incoming fluid to multiple locations within the filter chamber 108. For example, the inlet 112 may divide, within the filter chamber 108, into multiple parallel flow passages that terminate at different locations within the filter chamber 108. The inlet also may be perforated by holes or other openings, or otherwise provided with multiple outlets.

In the exemplary embodiment of FIG. 1, the second inlet passage 118 is held in place adjacent the first inlet passage 116 by a plurality of radial ribs 120 that are formed on the outside of the second inlet passage 118 or attached thereto. As shown in FIG. 2, the lower ends of the ribs 120 abut a step 122 formed in an annular wall 124 located at the outer circumference of the filter chamber bottom 106. The ribs 120 are sized such that they hold the second inlet passage 118 next to the first inlet passage 116 when the filter chamber wall 104 and filter chamber bottom 106 are assembled to the lid 102. When the interceptor 100 is assembled, the ribs 120 may be positioned radially inward of the filter chamber wall 104, which may also rest on the step 122. In this arrangement, the ribs 120 and filter chamber wall 104 are captured within the circumference of portion of the annular wall 124 extending upwards past the step 122, and thereby prevented from moving vertically or laterally with respect to the lid 102. As noted above, the filter chamber wall 104 may be joined to the filter chamber bottom 106 by any suitable attachment mechanism or means, and so, too, may the ribs 120.

The ribs 120 also may be shaped to hold or support the filter 110 at a predetermined location within the filter chamber 108. For example, the upper ends of the ribs 120 may terminate in a common plane to provide a base upon which the filter 110 rests. As shown in FIG. 2, the filter 110 may be captured between the ribs 120 and the bottom of the lid 102. To help capture in filter 110 in place, the lid 102 may include a downwardly extending annular ring 128 (or other structure or structures) that holds the filter 110 down towards the bottom of the filter chamber 108.

Where the ribs 120 are provided as continuous wall-like structures, such as in the shown embodiment, they also may form flow guides that divide the filter chamber 108 into separate vertically-extending flow paths. Alternatively, the ribs 120 may have cutouts or holes to allow fluid to pass laterally around the circumference of the filter chamber 108.

While the ribs 120 described above may be used in some embodiments, they are not required in all embodiments. For example, any number of ribs 120 may be used, or the ribs 120 may be omitted and substituted with other mechanisms or structures to hold the second inlet passage 118 (if used) to the first inlet passage 116, or to hold the filter 110 in place. For example, the second inlet passage 118 may be omitted, formed integrally with the first inlet passage 116, or attached to the first inlet passage 116 by other mechanisms, such as threads or other removable or non-removable mechanisms or adhesives, and the filter 110 may be mounted to the lid 102 or filter chamber wall 104 or bottom 106. The ribs 120 also may be modified so that they abut the bottom wall 126 of the filter chamber or otherwise provide vertical and/or lateral support for the second inlet passage 118. Still further, the ribs 120 also may be replaced by rods or other structures that hold the second inlet passage 118 adjacent the first inlet passage 116. These and other variations will be apparent to persons of ordinary skill in the art in view of the disclosures herein.

The filter 110 is provided in the filter chamber 108 and positioned, in a fluid sense, between the inlet 112 and the outlet 114. For example, in the exemplary embodiment of FIG. 1, the filter 110 is mounted towards the top of the filter chamber 108, above the inlet opening 130 (where the inlet 112 opens into the filter chamber 108), and below the outlet opening 132 (where the outlet 114 receives fluid from the filter chamber 108). The filter preferably is located physically above the inlet opening 130 to provide a volume in which the fluid must travel vertically from the inlet opening 130 before it reaches the filter 110. Providing this space is expected to allow heavier particles entrained in the fluid to settle out of the fluid by gravity before reaching the filter 110, and may allow particles that reach the filter 110 to fall away from the filter during idle periods when there is no fluid flow, or when the fluid is drained from the filter chamber 108. If desired, the filter chamber 108 may be sized to encourage a majority of the particles to precipitate out of the fluid before the fluid reaches the filter or the outlet opening. In such a case, if it is believed that a sufficient number of particles can be removed by the interceptor 100 to prevent the remaining particles from clogging downstream plumbing, the filter 110 may be removed entirely.

As shown, the filter 110 may comprise an annular filter that encircles the inlet 112 and extends radially to the filter chamber wall 104. The filter 110 encircles the top of the second inlet passage 118, and captured between the ribs 120 and the annular ring 128 formed at the bottom of the lid 102. The filter 110 may be removed along with the filter chamber wall 104 and filter chamber bottom 106 for service, cleaning, or replacement.

It will be understood that other filter shapes and arrangements may be used in other embodiments. For example, the filter may take any suitable shape and have any suitable construction to impede the movement of particles from the bottom of the filter chamber 108 to the outlet 114. The filter 110 may be positioned within the confines of the filter chamber wall 104, as shown, or it may be installed within the confines of the lid 102 and above the filter chamber wall 104. The filter 110 also may be removable with the filter chamber wall 104 (if the wall is removable), or it may be held in place with the lid 102 when the filter chamber wall 104 is removed. The filter 110 also may be located in the outlet 114 or at other locations downstream of the filter chamber 108.

The filter 110 may comprise any kind of filter or screen that helps remove particles from fluid passing from the inlet opening 130 to the outlet opening 132. Examples of suitable filters include, but are not limited to, open celled foams, porous solids (such as sintered plastic filters, porous concrete, and the like), sponges, woven or nonwoven flat or pleated filters (such as wet-laid, spunbonded, or meltblown natural or synthetic materials), mesh screens, perforated plates, porous packs of pellets, sand, or other filtration materials, and so on. The filter medium also may comprise a sorbtive filter media, be adapted to modify the pH of the fluid, adsorb or absorb chemicals or elemental materials such as iron or phosphorous, modify the ionic properties of the fluid, or otherwise condition the fluid passing through the system. Such filter materials are well-known by persons of ordinary skill in the art, and the selection of a particular material will depend on the particular conditions of the application for which the device is used. For example, some suitable solid alkali non-resin pH conditioning materials are described in publications such as the PHIX™ Neutralization Systems Cartridge System Technical Manual dated 2005, available from Green Turtle (USA) of Charlotte, N.C. Where a pelletized, powdered or other loose filter medium is used, the medium may be captured between or within screens or fabric sheets to control the distribution of the medium, as known in the art.

The filter 110 also may comprise a stack or collection of multiple filter layers. For example, the filter 110 may have a first, relatively coarse, filter layer at its upstream end, and one or more progressively finer filters located downstream of the first layer. In such an embodiment, smaller particles may penetrate further into the filter 110, which may increase the filter's life span and/or efficiency. The filter 100 also may include different chemical treatment layers, such as layers intended to remove phosphorous, heavy metals, and other pollutants from the fluid passing through the interceptor 100.

As noted above, the filter 110 may be captured in place, as shown, or mounted in other ways in the filter chamber 108. The details of how the filter 110 is mounted may vary depending on the shape and size of the interceptor 100, the pollutants or particulate matter that the filter is intended to remove, the location of the filter 110 in the filter chamber 108, and so on. Such variations will be readily apparent to persons of ordinary skill in the art in view of the present disclosure and/or with practice of the invention.

A bypass 134 may be provided between the inlet 112 and the outlet 114. The bypass provides a second fluid communication passage from the inlet to the outlet, in addition to the filter chamber 108. During normal operation, little or no fluid passes through the bypass 134. When the flow resistance of the interceptor 100 exceeds a threshold value, however, flow will pass through the bypass 134. This point at which the flow resistance meets this threshold value can be measured in any number of ways. For example, the value may be measured as the flow resistance necessary to cause the fluid in the inlet to rise to certain level in the inlet 112, or the flow resistance necessary to generate a particular head pressure on the filter 110 or at the lowermost point of the inlet 112 flow path (e.g., at the inlet opening 130). The head pressure may be measured in absolute terms (e.g., in relation to atmospheric pressure), or in relative terms (e.g., the pressure differential across the filter 110).

The exemplary bypass 134 joins the inlet 112 upstream of the filter chamber 108, and may be oriented to connect to the inlet 112 at an oblique angle so that fluid falling down the inlet 112 generally does not tend to flow into the bypass 134. The bypass 134 joins the outlet 114 downstream of the filter chamber 108. The bypass 134 may be provided as part of the lid 102, as shown, but this is not required. In other embodiments, the bypass 134 may join the inlet 112 at any location between the sink and the filter chamber 108, and may join the outlet 114 at any location downstream of the filter chamber 108. For example, the bypass 134 may rejoin the outlet 114 by simply being directed to the same open or closed drain into which the outlet 114 flows.

As shown, all or part of the bypass 134 may be located above the outlet 114. More particularly, the minimum flow elevation 134′ in the bypass 134—that is, the minimum point 134′ over which fluid must pass to traverse the bypass 134—is higher than the minimum flow elevation 114′ in the outlet 114. The minimum bypass flow elevation 134′ also may be greater than the maximum point over which fluid may pass through the outlet 114. In this arrangement, fluid entering the interceptor 100 generally will pass through the filter chamber 108, rather than through the bypass 134, provided there is little or no flow restriction in the filter chamber 108 or inlet 112. Bypass will only occur when there is sufficient blockage in the interceptor 100 (either in the filter chamber 108, the inlet 112, or the portion of the outlet 114 between the filter chamber 108 and the bypass 134) to cause fluid to back up the inlet 112 to the minimum bypass flow elevation 134′. The bypass 134 may be constructed to regulate when bypass occurs. For example, the height of the bypass arch or the location at which the bypass 134 joins the inlet 112 may be raised to increase the amount of backpressure generated in the interceptor 100 before bypass. In other embodiments, the bypass 134 may comprise a pressure-sensitive valve that opens when a certain amount of pressure is sensed in the inlet 112, or when sufficient pressure differential exists between the inlet 112 and the outlet 114. Such valves are known in the art, and any suitable relief valve or pressure-operated valve may be used for this application. In such embodiments, it may not be necessary for any part of the bypass 134 to be located above the outlet 114.

A removable liner 136 may be provided inside the filter chamber 108. The liner 136 is provided to collect dirt, particles, and other materials that may accumulate in the filter chamber 108 over time. The liner 136 may comprise a flexible bag or rigid cup-like structure that fits within the filter chamber 108, and which may conform to the filter chamber's inner wall. The liner 136 may be porous or fluid-impervious. For example, in one embodiment, the liner 136 may comprise a disposable mesh bag that fits in the filter chamber 108, and is captured at its open upper end between the filter chamber wall 104 and the lid 102. In such an embodiment, the liner 136 may be used to collect and remove solids such as coffee grounds, food particles, and the like from the filter chamber 108.

A filter chamber drain 138 may be provided at or near the bottom of the filter chamber 108. The drain 138 may have a plug or valve (not shown) to seal the drain 138 during normal use (i.e., when fluid it flowing through the interceptor 100 from the inlet 112 to the outlet 114), but allow the filter chamber 108 to be drained when desired. Alternatively, the drain 138 may remain open during normal use to allow slow drainage into a drain. In such embodiments, fluid will empty out of the filter chamber 108 during periods of non-use, which may be helpful to allow particles to fall out of the filter. An example of such an arrangement is illustrated in FIG. 4, in which a filter chamber drain 138 is attached to the sink's drain pipe 404′ by a hose 406. The hose 406 may have one or more quick-connect fittings that allow it to be installed and removed without tools, and which may also prevent fluid flow when the hose is not connected. Such hose fittings are known in the art. In embodiments having an open drain 138, a porous liner 136 or other kind of filter may be provided to cover the drain 138 and help prevent it from becoming clogged. As shown, the drain 138 may be in the bottom of the filter chamber 108, but it may be raised above the bottom of the filter chamber 108 to prevent particles in the fluid from settling over or in the drain 138.

The operation of the exemplary embodiment of an interceptor 100 of FIG. 1 is illustrated in FIGS. 2 and 3, in which dotted lines with arrows illustrate typical flow paths through the device. FIG. 2 illustrates the interceptor 100 during normal operation, and FIG. 3 illustrates the interceptor 100 during blocked flow operation.

Referring to FIG. 2, during typical operation, fluid flows through the inlet 112 and into the filter chamber 108 by way of the inlet opening 130. The fluid then reverses and flows upwards to the filter 110. During this upward flow, heavier particles may precipitate out of the flow. The fluid next passes through the filter 110, which captures some or all of any particles that may remain entrained in the fluid. As noted above, the filter 110 also may be adapted to capture or remove pollutants or other substances from the fluid. The cleaned fluid then passes into the outlet opening 132, and leaves the interceptor 100 via the outlet 114. From here, the fluid may travel to a downstream sewer drain, a treatment chamber or facility, or some other downstream destination.

The interceptor 100 and filter 110 may be dimensioned and selected such that the typical expected flow rate into the inlet 112 is relatively low compared to the flow resistance of the interceptor 100 and filter 110. Thus, the incoming fluid typically can pass through the filter chamber 108 and filter 110, and does not back up in the inlet 112.

It should be appreciated from the foregoing disclosure that the number of particles that precipitate out of the fluid before the fluid passes through the filter 110 may be enhanced by decreasing the velocity of the fluid. For a given flow rate, the fluid velocity can be reduced by increasing the horizontal cross sectional area of the filter chamber 108, and vice versa. Generally, lower velocities are expected to result in greater amounts of non-buoyant (e.g., heavier-than-water) particles being precipitated out of the fluid before striking the filter 110. Where the cross sectional area of the filter chamber 108 can not be increased (such as where there are space constraints), the filter chamber 108 can be elongated vertically to reduce the likelihood that non-buoyant particles will flow all the way up to the filter 110.

While the interceptor 100 may be designed to reduce or minimize the amount of particles that rise all the way to the filter 110, this is not required, and it is expected that some non-buoyant particles will strike and possibly be retained in the filter 110. In addition, buoyant particles are likely to rise to the filter 110 and may remain in contact with the filter 110 until the filter 110 is cleaned or the particles become saturated and sink to the bottom of the interceptor 100. Particles that strike and remain captured by the filter 110 may be removed and cleaned by removing the filter chamber wall 104 and/or filter chamber bottom 106, by backflushing the filter chamber 108, or by other mechanisms or means.

Referring now to FIG. 3, the interceptor 100 may periodically become partially or entirely blocked. This may occur during expected intervals, such as when the particles being washed away from the sink accumulate in the filter chamber 108 or on the filter 110 in sufficient quantity to substantially inhibit or block the flow of fluid through the filter chamber 108. Blockage also may occur if a large object 302 becomes lodged in the inlet 112 or filter chamber 108. In either of these events, the flow rate through the filter chamber 108 may become sufficiently inhibited to cause fluid to start backing up the inlet 112. At such times, the sink operator may notice the fluid draining more slowly (or not at all), and may then check on the source of the obstruction and clean the interceptor 100.

In order to prevent fluid from backing all the way up to the sink, the interceptor 100 may include a bypass 134, such as described previously herein, which allows backed-up fluid to pass directly from the inlet 112 to the outlet 114. As shown, the bypass 134 may comprise an arched passage, or it may have other shapes. A water sensor (not shown), such as those known in the art, may be installed in the bypass 134. The water sensor may comprise any electronic or mechanical signaling device, and it may be located anywhere in the bypass 134. For example, the water sensor may comprise an electric water sensor, located at the top of the arched bypass 134, that activates a light or buzzer to signal when water is passing though the bypass 134.

Referring now to FIG. 4, further details of exemplary embodiments of the invention are described in more detail. FIG. 4 illustrates an interceptor 100 such as that shown in FIG. 1 being installed in the drain pipe 404, 404′ of a sink 402. It will be appreciated that, when so installed, the drain pipes 404, 404′ may be considered or provided as separate parts, or simply as extensions of the inlet 112 and outlet 114, respectively. If the sink plumbing includes a P-trap or S-trap, the interceptor 100 may be located upstream or downstream of the trap. A first portion of the sink drain pipe 404 extends from the sink 402 to the inlet 112, and a second portion of the sink drain pipe 404′ extends from the outlet 114 to a downstream location, such as a sewer or wastewater treatment tank or facility. The interceptor 100 of this embodiment may be shaped and sized to fit in a typical under-sink space. The lid 102 may be relatively fixedly attached to the drain pipe 404, 404′, with the intention being that it should not have to be removed except under extraordinary circumstances. In such embodiments, the filter chamber wall 104 and filter chamber bottom 106 may be connected to one another to form a cup-like container 408 that is removably connected to the bottom of the lid 102 for service and cleaning. The container 408 has a top opening that mates with the lid 102 to form a water-resistant seal.

In the embodiment of FIG. 4, sink water and entrained solids or particles enter the interceptor 100 through the inlet 112, and pass to the bottom of the filter chamber 108. From there, the fluid rises through the filter 110, and exits through the interceptor outlet 114. A bypass 134 may be provided to convey the fluid around the filter chamber 108 if the interceptor 100 becomes clogged. During idle periods, the fluid level in the interceptor 100 may drop to the height of the bottom edge of the outlet 114, assuming no siphoning occurs. Siphoning can be prevented by providing a vent (not shown) in the drain pipe 404′, or by the bypass 134, which can vent air past the filter chamber 108.

The interceptor 100 may be serviced by removing the container 408 from the bottom of the lid 102 and cleaning it out. A liner (not shown), such as described above, may be provided in the container 408 to further assist with cleaning the interceptor 100. In this embodiment, the fact that the water level remains at the level of the outlet 114 can present a situation that arises during servicing. In particular, at least a portion of the upper edge of the container 408 may be mounted below the level of the minimum outlet flow elevation 114′ by a distance “h,” as shown in FIG. 4. Thus, the fluid may tend to spill out of the container 408 at this point (or other locations) when the container 408 is removed from the lid 102. The amount of fluid and consequences of such spillage may not cause concern in some embodiments, in which case it need not be addressed. In other embodiments, it may be desirable to reduce or eliminate the possibility that fluid will spill when the container 408 is removed. In such cases, there are several ways to reduce spillage.

On way to reduce or eliminate spillage is to provide a filter chamber drain 138 that can be used to drain some or all of the fluid from the filter chamber 108 prior to removing the container 408. As noted above, such a drain 138 may be attached to the sink drain pipe 404′ by a hose 406, or it may empty into a removable bucket or other container. The drain 138 may be open at all times, or it may include a valve 410 to control when it is opened. Another way to reduce or eliminate spillage is to siphon fluid out of the system through the inlet 112 or outlet 114 (the outlet 114 may be accessible through an air vent). Such a siphon also may be installed through a dedicated opening, such as an opening located between the sink and the inlet 112. The siphon may be removable or permanently installed. These and other variations will be apparent to persons of ordinary skill in the art in view of the disclosures herein.

Another way to reduce or eliminate spillage is to provide a displacement member that occupies a portion of the internal volume of the container 408 when it is mounted to the lid 102. For example, in the embodiment of FIGS. 1-4, the lid's annular ring 128 has a thick wall forming an displacement member that occupies a significant volume of the filter chamber 108 within the confines of the filter chamber wall 104. As the container 408 is lowered from the lid 102, the displacement member is withdrawn from the container 408, and the fluid located between the lowermost point of the top of the container 408 (i.e., the portion(s) of the container's top opening over which fluid would flow if the container is overfilled) and the minimum outlet flow elevation 114′ can flow down into the chamber 408 to a level below the lowest point of the container's top opening. To this end, the displacement member may have a total volume that equals or exceeds the volume of fluid that can remain in the portion of the filter chamber 108 located vertically between the minimum outlet flow elevation 114′ and the lowermost point of the container's top opening. Similarly, if the inlet 112 becomes blocked at a point below the container opening, fluid may remain in the inlet 112 above the lowest point of the container's top opening, but below the minimum bypass flow elevation 134′. To account for such fluid being present, the displacement member volume may be increased to additionally include or exceed the total volume of fluid that might be located in the portion of the inlet 112 located vertically between the minimum bypass flow elevation 134′ and the lowermost point of the chamber's top opening.

In order to prevent fluid from spilling out of the chamber 408 as it is being lowered, the lid 102 and chamber 408 may be constructed to remain in sealed or partially-sealed contact with one another as the container 408 is being removed. For example, in the shown embodiment, the displacement member comprises an annular ring 128 having an outer circumferential surface that remains in contact with the container 408, for a distance as the container 408 is being removed. This distance may be selected in conjunction with the volume of the displacement member to allow all of the fluid that might be located above the lowermost point of the chamber opening to descend into the container 408 before the seal is broken. Such sealing contact may be enhanced by providing one or more o-rings, lip seals, or gaskets at various heights around the outer circumferential surface. In other embodiments the sealing surfaces may be formed separately from the displacement member. For example, the displacement member may be formed as a projection from the first inlet passage 116, and a separate annular wall may be provided to seal the lid 102 to the container 408. This and other variations will be understood by persons of ordinary skill in the art in view of the present disclosure.

The annular ring 128 that serves as the displacement member also may help hold the filter 110 in place within the filter chamber 108. In such an embodiment, the annular ring 128 may cover part of the filter 110, possibly inhibiting flow through the filter or preventing its full use. If so, the annular ring 128 may, if desired, be contoured otherwise modified to allow fluid to flow through a greater part of the filter 110. For example, the annular ring may be have scallops on its lower surface, radial notches, or other shapes to allow or encourage fluid to flow through more of the filter's volume.

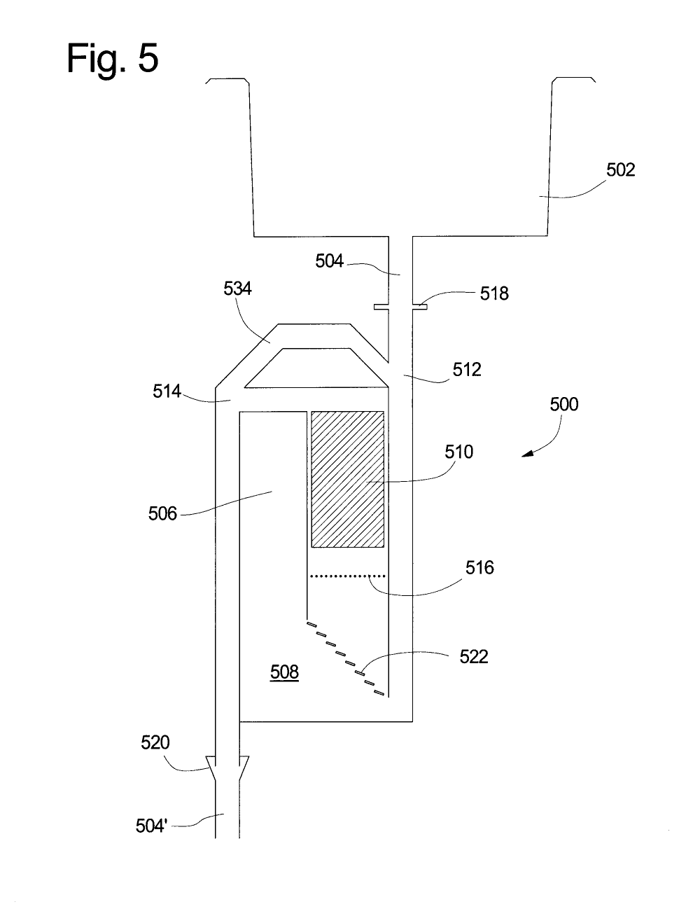

Referring to FIG. 5, another embodiment of an interceptor 500 of the present invention is illustrated and described. As with the previous embodiment, the interceptor 500 includes an inlet 512 and an outlet 514, which are positioned in-line with the drain pipes 504, 504′ for one or more sinks 502. The interceptor 500 includes a filter chamber 508 and a bypass 534, which provide two parallel flow paths from the inlet 512 to the outlet 514. During normal use, fluid flows into the inlet 512, passes through the filter chamber 508 and a filter 510 located in the filter chamber 508, and exits through the outlet 514. If the interceptor 500 becomes partially or fully blocked, fluid may bypass the filter chamber 508 through the bypass 534.

While the interceptor generally operates similarly to the previously-described embodiments, it may have several structural differences. For example, the inlet 512 may be located towards or at one side of the filter chamber 508, and the entire interceptor 500 may be removably mounted between couplings 518, 520. In this embodiment, the interceptor 500 may be removed in its entirety and tipped over to empty the filter chamber through the inlet 512. The bypass 534 may be constructed to provide a carrying handle for the interceptor 500. If additional cleaning is required, the filter 510 may be mounted on a removable drawer, or the interceptor 500 may include removable panels or a lid to access the filter chamber 508.

The filter chamber 508 may include a riser space 506 located horizontally adjacent or above the filter 510. The riser space 506 provides a space in which buoyant particles 510 can float without pressing against the filter surface. A vent (not shown) may be provided between the riser space 506 and the outlet 514 or the upper portion of the filter 510 to prevent air from being trapped in the riser space 506. A mesh or second filter may be located over the vent to particles from exiting the riser space therethrough. The filter chamber 508 also may include one or more vanes 522 to urge buoyant particles away from the filter 510. In addition, a screen 516 may be located below the filter 510 to help prevent it from becoming blocked by buoyant particles.

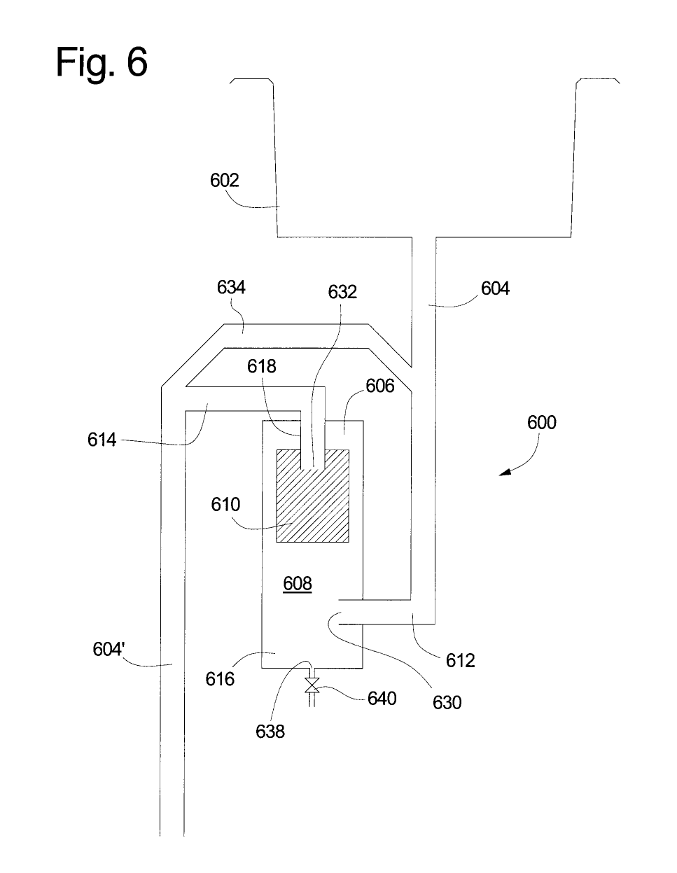

Another exemplary embodiment of an interceptor is illustrated in FIG. 6. In this embodiment, the interceptor 600 again includes an inlet 612 and an outlet 614 that are positioned in series with the drain pipes 604, 604′ of a sink 602. The interceptor 600 includes a filter chamber 608 and a bypass 634, which provide two parallel flow paths from the inlet 612 to the outlet 614. During normal use, fluid flows into the inlet 612, passes through the filter chamber 608 and a filter 610 located in the filter chamber 608, and exits through the outlet 614. If the interceptor 600 becomes partially or fully blocked, fluid may bypass the filter chamber 608 through the bypass 634.

In this embodiment, the inlet 612 enters the side of the filter chamber 608. A riser space 606 may be provided horizontally adjacent the filter 610, and a settling space 616 may be provided below the inlet 612 to allow denser particles to accumulate without blocking the inlet opening 630. Of course, such riser and settling spaces 606, 616 may be provided in any other embodiment of the invention, such as the embodiment of FIG. 1. The filter 610 may be removably mounted to a pipe 618 that forms the outlet opening 632 or otherwise retained in the filter chamber 608.

In the embodiment of FIG. 6, the filter chamber 608 may be provided as a simple canister to which conventional plumbing pipes and fixtures are attached to form the interceptor's inlet 612, outlet 614, and bypass 634. Thus, this embodiment may reduce the total cost of the interceptor 600, and may provide more flexibility for incorporating the interceptor 600 into existing plumbing and confined spaces. For example, an interceptor such as that shown in FIG. 6 may be constructed using off-the-shelf parts available at a plumbing supply store. A large-diameter pipe (such as a typical polyvinyl chloride (“PVC”) plumbing pipe) may be used for the filter chamber 608 by installing caps on either end, and conventional smaller diameter plumbing pipes may be used for the remaining passages. A simple mesh screen may be used as the filter 610. When it is desired to clean the interceptor 600, the lower cap may be removed from the filter chamber 608. If desired, a drain 638 and valve 640 may be provided to empty the filter chamber 608 into a bucket or elsewhere before such service.

The exemplary embodiments described herein are not intended to limit the scope of the appended claims. Furthermore, the claims may be practiced in any number of other ways, and, where suitable, in other contexts. For example, although embodiments disclosed herein have been described as under sink interceptors for food byproducts, the principles and structures herein are applicable to other settings. Modifications to the exemplary embodiments and other embodiments of the claimed invention will be apparent to those of ordinary skill in the art in view of the present disclosure, and such modifications are intended to fall within the scope of the following appended claims. Accordingly, the claims set forth below should be construed broadly to encompass the full breadth and spirit of the claimed inventions.

1. An interceptor comprising:
a filter chamber;
an inlet passage fluidly connected to the filter chamber at an inlet opening;
an outlet passage fluidly connected to the filter chamber at an outlet opening, the outlet opening being located above the inlet opening and having a minimum outlet flow elevation at which fluid can pass through the outlet passage;
a filter positioned in the filter chamber between the inlet opening and the outlet opening such that substantially all of a fluid passing from the inlet opening to the outlet opening must pass through the filter; and
a bypass passage fluidly connecting the inlet passage to the outlet passage, the bypass passage having a minimum bypass flow elevation at which fluid can pass through the bypass passage, the minimum bypass flow elevation being higher than the minimum outlet flow elevation.

2. The interceptor of claim 1, wherein the filter chamber comprises a lid having a bottom opening, and a container removably attached to and extending downward from the bottom opening.

3. The interceptor of claim 2, further comprising one or more toggle clamps adapted to hold the container to the lid.

4. The interceptor of claim 2, wherein the inlet passage and outlet passage pass into the filter chamber through the lid.

5. The interceptor of claim 1, wherein the filter chamber comprises a top wall, a bottom wall and a sidewall joining the top wall to the bottom wall to form an enclosed space.

6. The interceptor of claim 5, wherein the inlet passage enters the filter chamber through the top wall and the inlet opening is located adjacent the bottom wall.

7. The interceptor of claim 5, wherein the sidewall comprises a vertically-oriented cylindrical sidewall.

8. The interceptor of claim 7, wherein the inlet passage enters the filter chamber through the top wall, the inlet opening is located adjacent the bottom wall, and the inlet passage and inlet opening are located proximal to a center axis of the cylindrical sidewall.

9. The interceptor of claim 8, wherein the filter comprises an outer perimeter shaped to fit within the vertically-oriented cylindrical sidewall, and an inner opening shaped to fit around the inlet passage.

10. The interceptor of claim 9, wherein:
the vertically-oriented cylindrical sidewall is removable from the filter chamber top wall;
the inlet passage comprises a first inlet passage connected to and extending through the top wall, and a second inlet passage removably connected to the first inlet passage and extending from the first inlet passage to the inlet opening; and
the filter inner opening is shaped to fit around the second inlet passage.

11. The interceptor of claim 10, wherein the second inlet passage comprises one or more radial protrusions adapted to hold the second inlet passage vertically between the filter chamber bottom wall and the first inlet passage.

12. The interceptor of claim 10, wherein the second inlet passage comprises one or more radial protrusions adapted to hold the filter at a fixed distance from the inlet opening.

13. The interceptor of claim 10, wherein the second inlet passage comprises one or more radial protrusions adapted to hold the second inlet passage vertically between the filter chamber bottom wall and the first inlet passage and to hold the filter at a fixed distance from the inlet opening.

14. The interceptor of claim 1, further comprising a filter chamber drain providing a fluid passage from the filter chamber to a point downstream of the outlet opening.

15. The interceptor of claim 14, wherein the filter chamber drain is selectively closable.

16. The interceptor of claim 1, further comprising a filter chamber liner adapted to removable install within the filter chamber.

17. The interceptor of claim 1, wherein the filter comprises a mesh screen.

18. The interceptor of claim 17, wherein the filter comprises a filter medium adapted to modify the pH of the fluid.

19. The interceptor of claim 1, wherein the filter comprises an open-celled foam material.

20. The interceptor of claim 1, wherein the filter comprises a plurality of different filter media.

21. The interceptor of claim 20, wherein the filter comprises a filter medium adapted to modify the pH of the fluid.

22. The interceptor of claim 1, wherein the filter comprises a filter medium adapted to modify the pH of the fluid.

23. An interceptor comprising:
a filter chamber;
an inlet passage fluidly connected to the filter chamber at an inlet opening;
an outlet passage fluidly connected to the filter chamber at an outlet opening, the outlet opening being located above the inlet opening;
a filter positioned in the filter chamber between the inlet opening and the outlet opening such that substantially all of a fluid passing from the inlet opening to the outlet opening must pass through the filter; and
a bypass passage fluidly connected to the inlet passage at a first point, and to the outlet passage at a second point, the bypass passage being adapted to allow flow therethrough only when a flow resistance between the first point and the filter exceeds a threshold value.

24. The interceptor of claim 23, wherein the bypass passage comprises a pressure-sensitive valve adapted to open when the fluid pressure in the inlet passage exceeds a predetermined threshold.

25. An interceptor comprising:
a treatment chamber comprising a lid and a container, the container having an open top adapted to removably connect to the bottom of the lid;
an inlet passage fluidly connected to the treatment chamber at an inlet opening;
an outlet passage extending through the lid and being fluidly connected to the treatment chamber at an outlet opening, the outlet opening being located above the inlet opening and having a minimum outlet flow elevation at which fluid can pass through the outlet passage;
a displacement member associated with the lid, the displacement member extending into the container when the container is attached to the lid;
wherein the treatment chamber and the outlet passage define a first volume when the container is connected to the bottom of the lid, the first volume comprising a first internal space within at least one of the treatment chamber and outlet passage located vertically between the minimum outlet flow elevation and a lowermost point of the open top of the container; and
wherein the displacement member occupies a second volume within the container when the container is connected to the bottom of the lid, the second volume being equal to or greater than the first volume.

26. The interceptor of claim 25, further comprising a bypass passage fluidly connecting the inlet passage to the outlet passage, the bypass passage having a minimum bypass flow elevation at which fluid can pass through the bypass passage, the minimum bypass flow elevation being higher than the minimum outlet flow elevation.

27. The interceptor of claim 26, wherein:
the inlet passage and the bypass passage define a third volume when the container is connected to the bottom of the lid, the third volume comprising a third internal space within at least one of the inlet passage and the bypass passage located vertically between the minimum bypass flow elevation and the lowermost point of the open top of the container; and
The displacement member further occupies a third volume within the container when the container is connected to the bottom of the lid, the third volume being equal to or greater than the first volume.

28. The interceptor of claim 25, further comprising a filter positioned in the filter chamber between the inlet opening and the outlet opening such that substantially all of the fluid passing from the inlet opening to the outlet opening must pass through the filter.

29. The interceptor of claim 28, wherein the displacement member is adapted to hold the filter at a vertical distance from the outlet opening.

30. The interceptor of claim 25, wherein the displacement member is integrally formed with the lid.

31. The interceptor of claim 25, wherein the displacement member comprises a part that is separately made and subsequently attached to the lid.

32. An interceptor for treating a generally homogeneous mixture of fluid and particles, the interceptor comprising:
a treatment chamber;
an inlet passage adapted to receive a generally homogeneous mixture of fluid and particles, the inlet passage being fluidly connected to the treatment chamber at an inlet opening;
an outlet passage fluidly connected to the treatment chamber at an outlet opening, the outlet opening being located above the inlet opening and having a minimum outlet flow elevation at which fluid can pass through the outlet passage; and
a bypass passage fluidly connecting the inlet passage to the outlet passage, the bypass passage having a minimum bypass flow elevation at which fluid can pass through the bypass passage, the minimum bypass flow elevation being higher than the minimum outlet flow elevation;
wherein the treatment chamber comprises one or more vertical passages between the inlet opening and the outlet opening, the one or more vertical passages being sized, in relation to a maximum flow rate of the generally homogeneous mixture, to cause a majority of the particles to precipitate out of the fluid before the fluid reaches the outlet opening.

33. The interceptor of claim 32, further comprising a filter positioned in the treatment chamber between the inlet opening and the outlet opening such that substantially all of a fluid passing from the inlet opening to the outlet opening must pass through the filter.

34. The interceptor of claim 32, wherein the fluid comprises water and the particles comprise coffee grounds.
